(19) United States
(12) Patent Application Publication
(10) Pub. No.: US 2002/0010638 A1
(43) Pub. Date: Jan. 24, 2002

(54) Method and system for mixed-mode electronic commerce processing of on-line orders

(76) Inventor: Addison M. Fischer, Naples, FL (US)

Correspondence Address: NIXON & VANDERHYE P.C., 8th Floor, 1100 North Glebe Road, Arlington, VA, 22201, US

(21) Appl. No.: 09/825,354

(22) Filed: Apr. 4, 2001

Related U.S. Application Data
(60) Provisional application No. 60/194,410, filed on Apr. 4, 2000.

(51) Int. Cl. G06F 17/60

(52) U.S. Cl. 705/26

(57) ABSTRACT

A mixed-mode method and system for performing e-commerce transactions between a user and a vendor, including creating an order list in an off-line environment, sending the order list to the vendor, making the order list available to the user through a real-time connection with the vendor, establishing a real-time connection between the user and the vendor and enabling the user to review and approve the order list during the real-time connection. The order list is preferably created using an e-mail or word processing program on the user's computer and is sent to the vendor via e-mail. A web browser is then used to establish the on-line connection with the vendor's site to review and approve the off-line created order while on-line with the vendor Once the order is approved through the on-line process, the order is processed in a conventional manner to complete the transaction.

### FIELD OF THE INVENTION

The present invention relates to the field of e-commerce and, more particularly, to a method and system for performing mixed-mode e-commerce processing of on-line orders. Specifically, the present invention relates to a method for operating a computer network to do electronic commerce related processing, wherein the details of an order are supplied by a user to a vendor in a manner that is different from the manner in which the order is approved by the user for processing by the vendor.

### BACKGROUND AND SUMMARY OF THE INVENTION

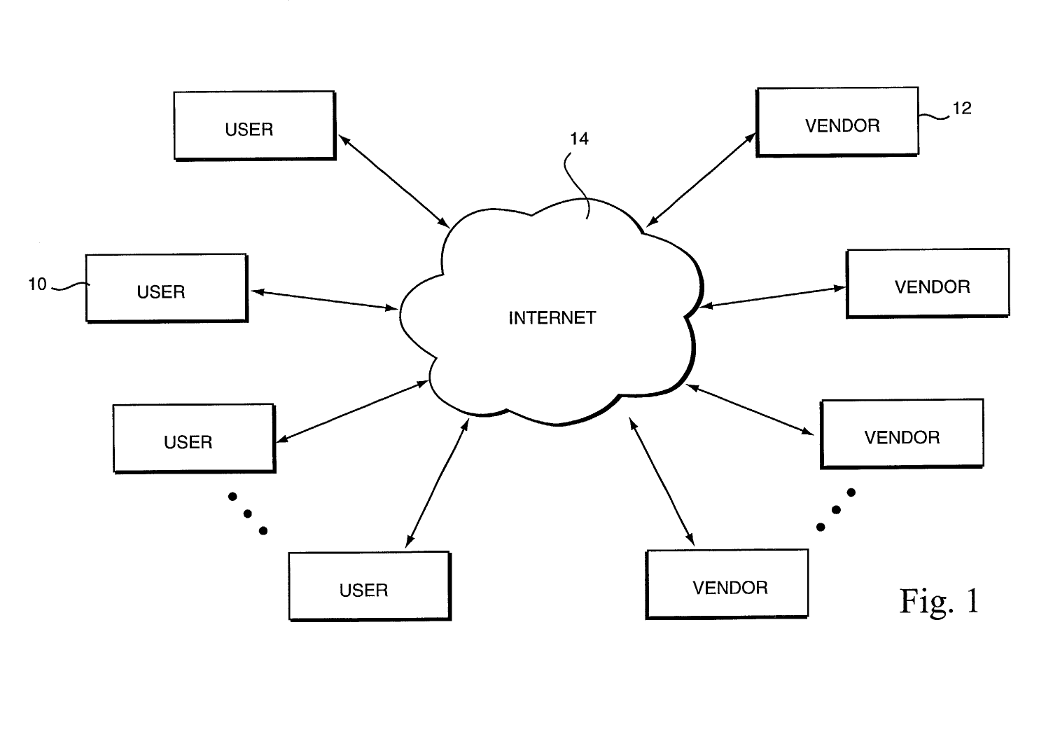

The instant invention is designed to be implemented in a network environment, such as the Internet environment shown in FIG. 1. FIG. 1 shows a typical Internet environment for conducting e-commerce transactions between one or more users 10 and one or more vendors 12. In this and similar network environments, users log onto or otherwise establish a real-time connection with a vendor (such as through a web site) for the purpose of purchasing products and/or services from the vendor. Vendor web sites typically include functionality that enables a user go to the web site and review and select items for purchase. Such selections are often placed in a “order basket” or “shopping cart” until the user is ready to complete the purchase transaction using an automated “check out” process or the like. The check out process typically involves reviewing, finalizing and approving the selected items for purchase. Thus, in the conventional e-commerce environment, the user performs the selection and approval process while in real-time or while on-line with the vendor.

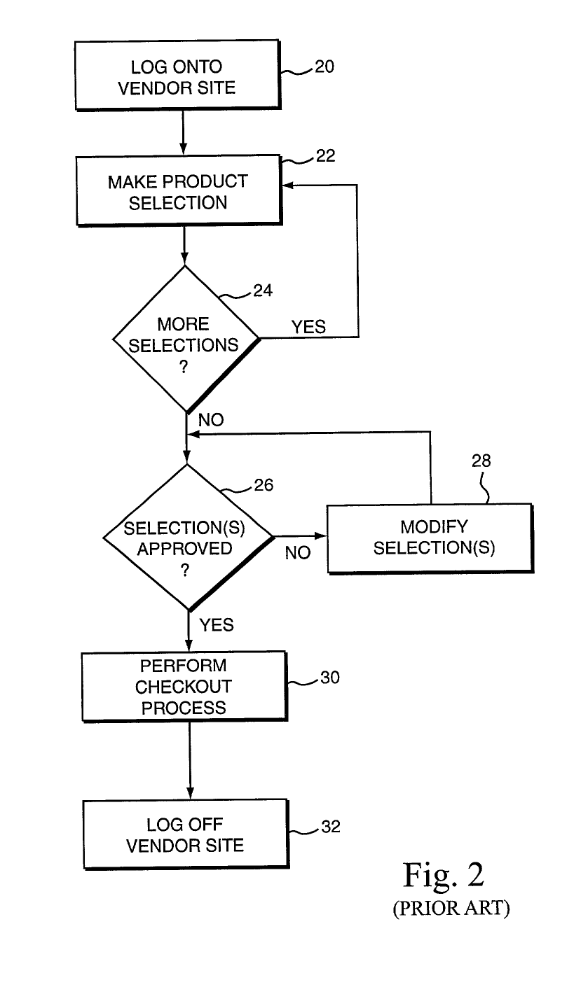

In typical current “Consumer to Business” electronic commerce transactions, users log onto the vendor's site, make selections, then proceed through an often times laborious “checkout” process whereby the purchase is usually completed. FIG. 2 shows a typical method used for conventional on-line purchases. First, the user logs onto the vendor's site (step 20). Then the user makes his or her selections (step 22) until the selection process is complete (step 24). Once the selections or purchase list has been completed, the user typically is given an opportunity to approve the list for purchase (step 26). If the list is not approved, the user is given an opportunity to modify the list (step 28). Once the list is approved, the user performs the checkout process (step 30) to actually purchase the items on the list. Once the purchase transaction is complete, the user logs off the vendor site (step 32) and waits to receive the items purchased from the vendor.

As can be seen from FIG. 2, the selection process and the approval process for a transaction are both performed while the user is on-line with the vendor site. This single mode transaction process for both creating an order list and approving the order list has several disadvantages. For example, if the on-line connection is slow it can take a significant amount of time for the user to complete the transaction. Also, if the on-line connection is temporarily unavailable, the user is prevented from performing any part of the order transaction process. In addition, the user cannot take advantage of the fact that he may have some of the information needed for the order in electronic form, because the user must actually create the order from scratch while on the vendor site. This leads to possible mistakes that could be avoided if the user could use the electronic information he or she already has when constructing the order. Moreover, the user cannot use familiar programs, such as word processors and/or e-mail programs, to construct the order - instead the user must use an interface that the vendor has provided on its web site to formulate the order. The conventional method is tedious, slow and often complicated, particularly, when large orders including many items are involved.

This instant invention addressed these and other problems by providing a method and system that enables mixed mode e-commerce order processing. Specifically, the instant invention enables a first mode, such as a word processor or e-mail program, to be used to formulate an order, and a second mode, such as an Internet browser, to provide approval of the order. In accordance with a preferred embodiment of the invention, the user creates a file that contains an order list and then send the order list to the vendor via e-mail or the like. Once the vendor receives the order list, the order is extracted from the transmission and the order is made available to the user through an on-line connection, such as through a web site. The user can then log onto the web site, review the order previously sent and quickly approve the order for processing by the vendor. Thus, the instant invention uses one mode for preparing the order and a different mode for approving the order. In this way, the speed and efficiency of the ordering and approval processor is significantly improved for the user.

### BRIEF DESCRIPTION OF THE INVENTION

These and other objects, features and advantages of the instant invention will become apparent from the following detailed description of the invention when read in conjunction with the appended drawings, in which:

FIG. 1 is a schematically shows a typical network environment in which the instant invention may be implemented;

FIG. 2 is a flow chart showing the typical prior art method of performing e-commerce order processing;

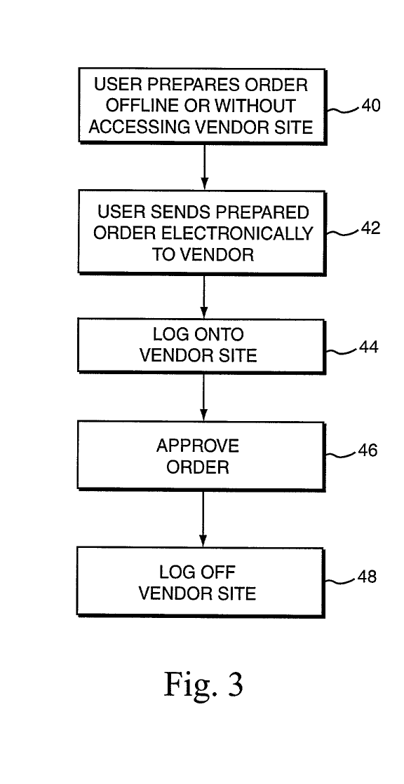

FIG. 3 is a flow chart showing a first embodiment of the mixed-mode order processing method of the instant invention;

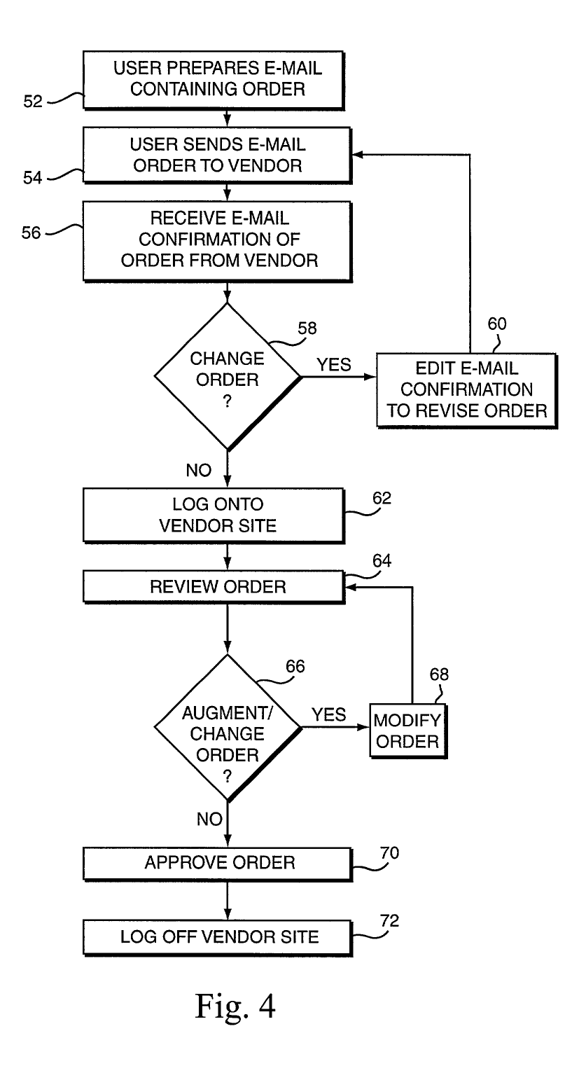

FIG. 4 is a flow chart showing another embodiment of the mixed-mode order processing method of the instant invention;

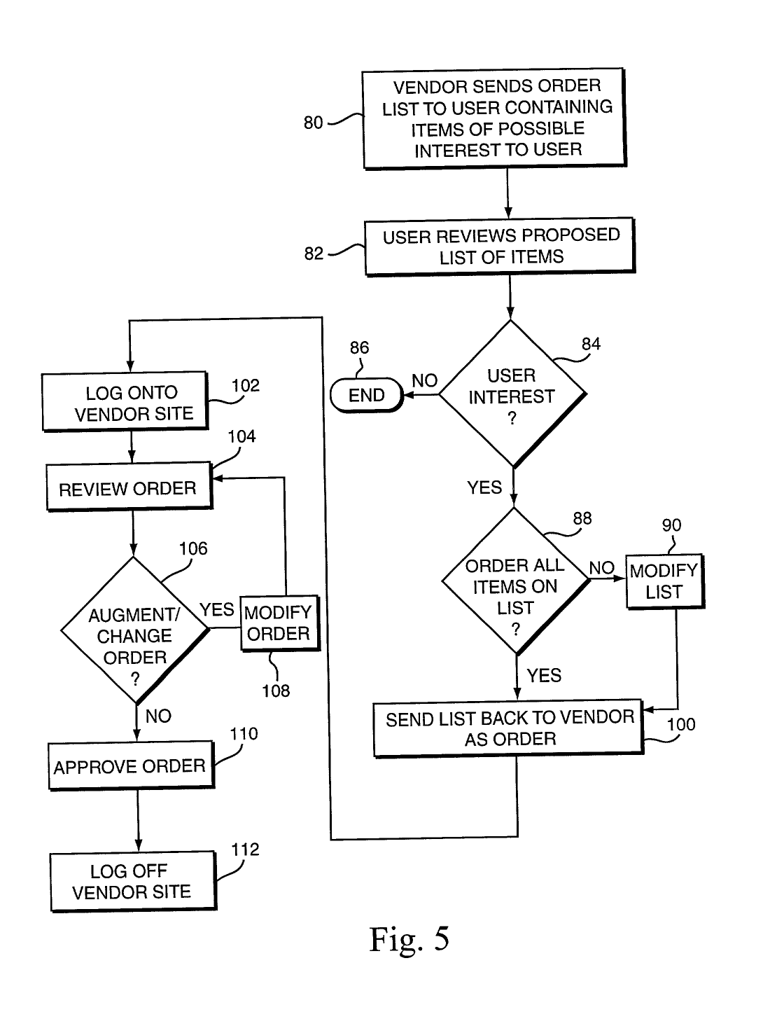

FIG. 5 is a flow chart showing a further embodiment of the mixed mode processing method of the instant invention;

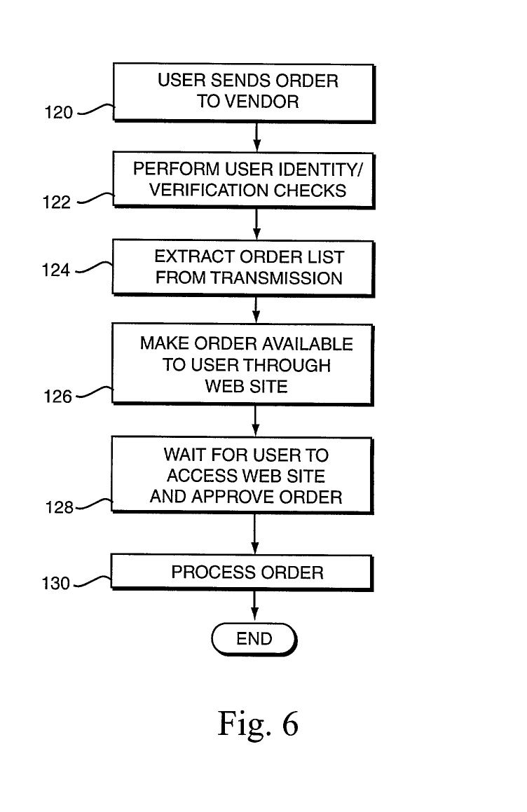

FIG. 6 is a flow chart showing a preferred embodiment of the methods of FIGS. 2-5 as performed by the vendor upon receipt of an off-line order;

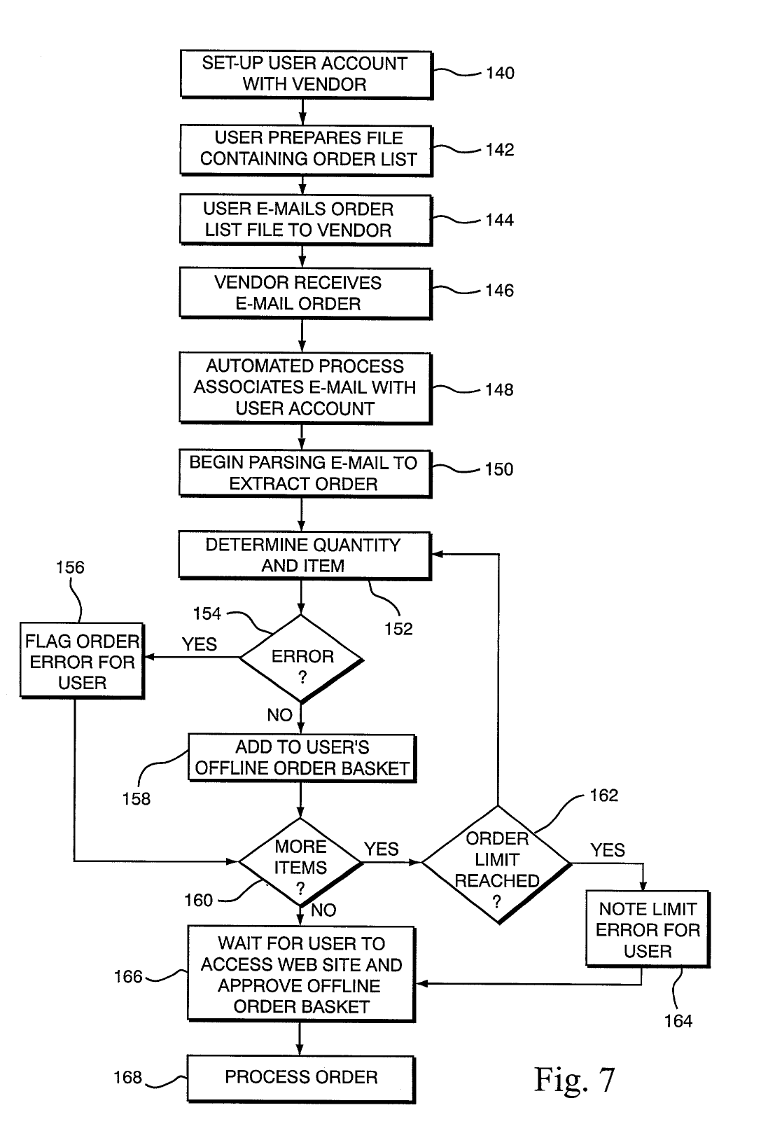

FIG. 7 is a flow chart showing another embodiment of the methods of FIGS. 2-5 as preformed by the vendor in connection with an off-line order; and

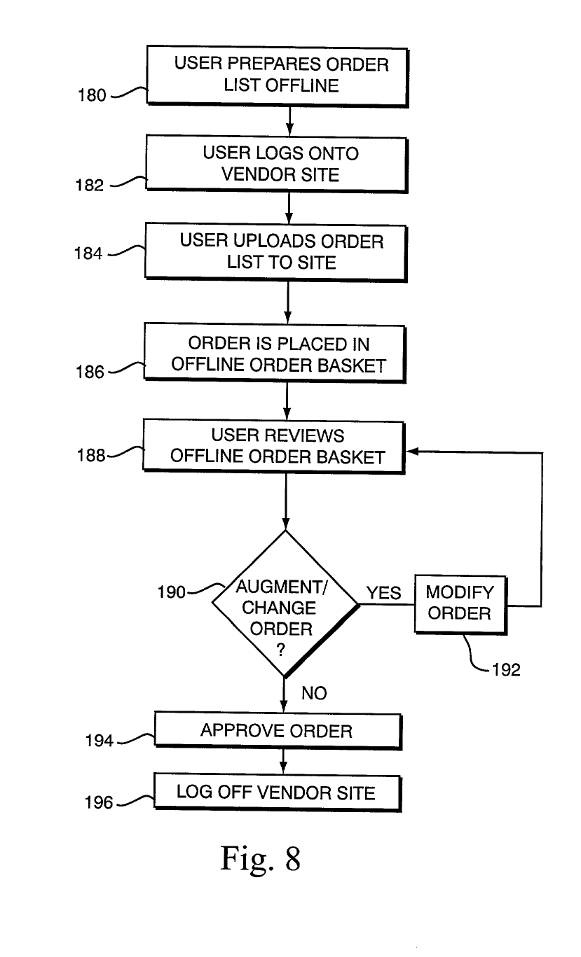

FIG. 8 is a flow chart showing an alternative embodiment of the instant invention, wherein the user uploads an order after logging onto a vendor site.

### DETAILED DESCRIPTION OF THE PREFERRED EMBODIMENTS

Referring now to the drawings, and more particularly to FIG. 1, the instant invention is designed to be implemented in a network environment, such as in an Internet environment. While the invention is particularly advantageous when used in connection with order processing over the Internet 14, the invention can be used in any suitable network environment where users and vendors are involved in e-commerce transactions or the like.

It is noted that the term “vendor” is used to encompass not only the actual vendor entity, but any agent, affiliate, subcontractor, or other entity acting on behalf of a vendor, such as service bureaus, facilities management companies, and/or the like. The term “vendor” also includes persons as well as software agents or the like. In addition, the term “vendor” applies not only to entities which sell products, but to any entity to which consumers submit lists of requests, such as for example, public service facilities which dispense information. In other words, the term “vendor” covers any entity or group of entities which process information received from “users”. The terms “supplier” and “receiver” may also used herein in place of “vendor” and are to be given the same broad meaning. In accordance with one embodiment of the invention, the vendor will be an automated computer process involving a minimum of human intervention, if any.

Similarly, the term “user” as used herein is meant to cover any entity or group of entities that submits lists of information or requests to “vendors”. As will be described in detail below, the user requests (or “orders”) are subsequently verified by online techniques. The terms “submitter” or “presenter” may also be used herein in place of “user” and are to be given the same broad meaning.

One embodiment of the invention is shown in FIG. 3. In this embodiment, a method of operating a computer network to do electronic commerce related processing is provided by which information relating to details of a user's order is supplied to a vendor in a manner that is different than the manner in which the order is approved by the user for actual processing by the vendor. In contrast to the conventional user/vendor electronic commerce transaction, wherein users log onto the vendor's site, make selections (i.e. define order), then proceed through an often times laborious “checkout process” whereby the purchase is usually completed (see FIG. 2), the instant invention greatly improves the ease and efficiency by which such transactions take place. For example, this invention enables users to spend less time on-line by preparing their order “off-line” or through use of a tool other than an Internet browser or the like. This feature enables the interaction through a browser (or other on-line system) to be limited to the approval/purchase process rather than to the entire order and approval/purchase process. In accordance with an important aspect of the invention, the details of an order are supplied in a way (e.g., e-mail) that is different from the order confirmation or approval process (e.g., browser). This features enables detailed, complex or otherwise long orders to be prepared off-line, while also minimizing the on-line time required to submit and approve an order.

As shown in FIG. 3, the user creates an order off-line using any suitable off-line technique or tool, such as by a word processing program or an e-mail program on the user's computer (step 40). The order will typically include a list of items that the user desires to purchase or otherwise receive from a vendor. Once the order is prepared in the off-line environment, the order is then transmitted to the vendor using any suitable communication technique, such as by e-mail (step 42). Thus, the list of items to be purchased is established as an off-line list. The list may be manually created by the user or it may be prepared by an automated process which creates an output file that defines the purchase or order list. It is noted that, in some cases, the list may be prepared by a source other than the particular user that ultimately approves the order. The order may be transmitted by the user or by some other party or entity, even though the user ultimately provides an approval of the list.

The purchase or order list is transmitted from the user, or an affiliate of the user, to the vendor or to an affiliate or an agent acting on the vendor's behalf. To complete the order, the user logs onto a site (step 44) operated by the vendor, or by another entity on behalf of the vendor, and completes, augments and/or authorizes the purchase using online techniques (step 46). In other words, when the user logs onto the vendor site, the previously communicated order is available for the user to review and approve in the on-line environment. This enables the user to simply approve the previously prepared order without the need to create or re-create the order while on-line. As a result the amount of time that the user has to spend on-line to make an order is greatly reduced. The user also does not have to be as familiar with the vendor's site in order to place an order. Once the off-line order is approved using the on-line technique (i.e., by establishing an on-line connection with the vendor), the order is approved for actual processing by the vendor and the user then logs off the vendor's site (step 48).

While numerous benefits are achieved using the instant invention, some of the main benefits include: 1) reducing the time spent by the user assembling an order, especially if the order is large or detailed, if the connection between the user and the vendor is slow, or if all or part of the purchase list is already available to the user as computer data; 2) improving the accuracy of an order if all or part of the purchase list is already available in a file available to the user; and 3) improves the security of an offline transaction, especially in a world when e-mail is not fully authenticated or secure. Since the final commitment for purchase is made “online”, both the vendor and customer can be assured of at least the same level of security as available to other online purchases (as opposed to the possibly reduced level of security available with e-mail alone).

FIG. 4 shows a more detailed embodiment of the invention as compared to FIG. 3. In this embodiment, the user prepares an e-mail containing an order (step 52), and then sends the e-mail order to the vendor (step 54). The vendor then sends an e-mail confirmation to the user which contains the original order for review by the user (step 56). The user can then change the order, if desired (step 58) by, for example, editing the e-mail confirmation to revise the order (step 60). The revised order is then sent back to the vendor (step 54) and another e-mail confirmation is received (step 56). If upon review of the confirmation by the user, no changes are desired, the user logs onto the vendor site (step 62) where the order is available for the user to again review (step 66). At this stage, the user is preferably given the option of augmenting or further changing the order. For example, the user may want to add additional items to the list or delete items from the list while on-line. Thus, the user can modify the order (step 68) and again review the order to assure that it is acceptable (step 64). If no further changes are desired the user approves the order while on-line (step 70). The approval process may be similar to a conventional “check out” process used on vendor sites. Once the order is approved, the user logs off the vendor site (steps 72). The vendor then has the approved order and begins processing of the order in a conventional manner for ultimate delivery to the user.

FIG. 5 shows another embodiment of the instant invention. In this embodiment, the vendor initiates the process by sending out via e-mail (or otherwise) lists suggesting items of possible interest to the user (step 80), such as lists of new books, movies, music, etc., which are available from the vendor, together with other related and important information such as price lists, part numbers, etc. The user then reviews the proposed list from the vendor to determine if he or she is interested in the items thereon. If the user is not interested in any item on the list, the user deletes the e-mail and the process ends (step 86). On the other hand, if the user is interested in all of the items on the list (steps 88), the user can accept the entire list by sending the list back to the vendor by e-mail (or otherwise) (step 100). If the user is only interested in some of the items on the list, the user can modify the list accordingly (step 90), using any suitable technique (such as an e-mail program or other editing program). The modified list can then be sent to the vendor as an order (step 100). Once the order is sent back to the vendor, the user can then perform an on-line approval process such as described previously with respect to FIGS. 3 and 4. Specifically, the user logs onto the site (step 102), reviews the order (step 104), edits the order if desired (steps 106, 108), approves the order (step 110), and then logs off the vendor site (step 112).

As shown in FIG. 5, the user can study the proposed list received from the vendor and quickly prepare a purchase list from this received document, such as by using a word processor to delete items which are not of interest, or perhaps by amending the list to indicate the items which are of interest. The user then can easily transmit the list back to the vendor as an order (typically by using the same form of communication). In cases where vendors permit users to delete existing orders, and if the vendor sends out confirmation lists following each purchase, this method provides an easy way for the user to amend the existing order without having to reassemble the entire order again. To do this, the user would simply edit their copy of the order confirmation, cancel (e.g., using an online technique) the original order, then e-mail the amended confirmation back to the vendor as a request for a new order. Once the document has been received and processed by the vendor, which may require no more than a matter of seconds, the user can access the vendor's site (using appropriate and available security and authentication) to confirm the e-mail order. This can be done without making the user tediously re-select items online. Of course, the vendor's system may also be designed so the user is able to supply yet more additional items to the order, or make other amendments once the order is loaded online, as described above.

Preferably, the vendor applies some level of security control when such e-mail order information is received and processed on behalf of a user. For example, with vendors for whom the sender's transmission identity (e.g., e-mail address) indicates the user's account identity, the user's transmission may be required to contain further identifying and authenticating information. With vendors for whom the e-mail does not define the user's identity, then the user's transmission identity (e.g., e-mail address) can be used as corroborating evidence, with the user's identity being indicated elsewhere in the transmitted material. In either case, it may desirable for additional corroborating evidence of the user's identity, authentication or authorization, such as a “password”, to be contained within the transmission. With e-mail, this information could be reflected in the body of the letter, in an attachment, or even as the subject (e.g., such as the user's account name).

Whether or not these security features are actually desirable in a particular implementation depends on the level of privacy and security the parties are willing to accord the mode of transmission (e.g., e-mail), and the protocols used by the parties. The corroborating information need not necessarily be a long-term password, but may be, for example, some single-use, or limited-use “password” assigned for (or by) the user during an online session. It may also be some type of digital signature such as one which can be verified by public key operations. Alternatively, it may merely be the user's account name, or it may relate to any number of other identification authentication or authorization protocols.

The main processing steps performed by the vendor, in accordance with a preferred embodiment of the instant invention, are shown in FIG. 6. As shown in FIG. 6, once the user sends an off-line created order to the vendor (step 120), the vendor processes the order (preferably using an automated process) to extract the order and make the order available to the user when the user logs onto the vendor site. The process preferably includes performing a user identity verification check (step 122) to identify the user. The file sent to the vendor is then analyzed and/or interpreted by the vendor (or automated process) to extract the order from the transmission (step 124). In other words, the user's transmission is reviewed so that the order can be established based thereon. Once the order is determined from the transmission, the vendor (e.g., automated process) makes the order available to the user (step 126) through its web site (or other similar on-line environment), so that it can be later verified or approved when the user connects online to the site. For example, the order could be added to the user's regular “shopping cart”, or perhaps to a different shopping card reserved for “off-line” transactions. Alternatively, a special shopping cart identified specifically in the submitting e-mail transaction could be used, or a special shopping basket could be used that is identified by, for example, the date and time or any other identifier that the user could use to find the order once on-line. Regardless of which “basket” the received order is placed, in preferred embodiment, the user would be able to purchase the order directly from that basket, or be able to efficiently move the items from that basket holding area to the main shopping basket. Also, in the preferred embodiment, the vendor would give the user the ability to further augment the basket, combine it with other received material, or otherwise modify it through online operations, as explained above.

Once the user logs onto the web site, finds the previously sent order in an appropriate “basket” or location and reviews/modifies the order, the order is then approved by the user (step 128). Once the order is approved, the vendor is then able to process the approved order (step 130) in a conventional manner using whatever level of online security is available and appropriate.

In processing the user's off-line transmission, the receiver (e.g., vendor) may search for special delimiters or patterns which are expected to delimit the content containing the items to be ordered. Depending on the needs of a particular application, the receiver's application might perform sophisticated content analysis to determine the specific nature of the content. For example, the receiver may scan for a first line of asterisks indicating the start of the list to be purchased, and stop when a second line of asterisks is detected. A more advanced receiver could scan for the text “Item” and use the word which follows as a product item number. In accordance with the invention any suitable method or process of decoding the transmission to obtain an order list therefrom may be used.

In order to prevent undue burden on the vendor, especially in defense of possible malicious activity by some users, or by some pranksters managing to transmit messages appearing to originate from a valid user, the vendor may limit the amount of storage space allowed to be occupied by lists submitted by a user. This could be done by, for example, limiting the aggregate storage space which a given user's lists may consume, or by limiting the duration for which such lists are kept without the user acting on them (i.e., going on-line and approving the list).

FIG. 7 shows another embodiment of the instant invention. In this embodiment, the user initially creates an account with the vendor (step 140). This is not strictly necessary—the vendor could accept e-mail orders from unknown users, and establish tentative accounts for a limited period of time assuming that users that would presumably log in later and match with the e-mail. However, this creates the risk of being choked by pranksters impersonating a large number of unknown users, and sending large amounts of mail. Requiring pre-defined user accounts allows the vendor to limit the amount of e-mail retained per account.

In this exemplary embodiment, the account is associated with the user's e-mail address, which is one of the indices by which the vendor is able to locate the account information. Typically the account information would also include the user's name, billing address, and possibly payment technique such as credit card.

As shown in FIG. 7 (and described above), the user prepares a file containing the list of products to be purchased (step 142), including whatever level is information detail is appropriate. For example, each line of the list may start with a quantity, separated by blanks from a product number or name. The user then e-mails the file to a special vendor mailbox, (e.g., Quickorder@vendor.com) (step 144). The vendor's system receives the e-mail for “Quickorder@vendor.com” (step 146), which is then handled by a special automated process (step 148) to associate the order with a user's account. The automated process preferably examines the sender's name which it uses to index into the user's account record. The automated process reads the e-mail and parses it to determine the desired order (step 150). For example, the process reads each line of the e-mail until it reaches a line starting with at least three asterisks, it performs detailed parsing on each line until it reaches the end of document (step 160), until it reaches another line starting with at least three asterisks, or until some predetermined “reasonable” line limit count is reached (step 162) (this last test prevents pranksters from submitting outrageously large e-mails with the intent of saturating the processing and/or storage power of the vendor's system).

The detailed parsing involves, for example, examining each order line, and interpreting the first value as a quantity. If it does not reflect a valid reasonable quantity number, the line is ignored or a reasonable quantity is assumed. The scan of the line continues, as appropriate, looking for the product number or name. In the preferred embodiment, the process distinguishes numbers and treat them as product numbers, while text will be treated as a name. In either case, the process uses this information to identify the product in its product database. In case of a name, the process can use some heuristic to select the best possible match in case of no exact match.

Once the product record is found, an associated entry is made in the user's “Off-line Order” basket (step 158). If the record is not found, then a place-holder entry is made (step 156) to alert the user when she eventually signs on, that the product identification is in error and should be corrected (step 156). Preferably, the vendor's process determines if the amount of material included in the transaction would exceed a predetermined threshold. The threshold may be uniform among all users or it may vary (allowing, for example, well-known and more trusted users to accumulate more). Preferably, the process can exercise corrective action if too much unprocessed material has accumulated. Depending on the implementation and the vendor's philosophy, this might include, for example, ignoring this transaction or deleting the oldest retained material to accommodate new material. This threshold test may be made one or more times as appropriate at various steps during the processing to protect the vendor's system capacity from being overwhelmed by malicious e-mail.

After logging onto the vendor's system (step 166), the user checks the “Offline Order” basket. The user then checks the order as explained above. In this preferred embodiment, the vendor's loading process has highlighted any order lines which contain errors (step 156, 164), or in which it found a flaw in the transmission or data. These might be, for example, highlighted in red. If there are no errors, or after the user has corrected, deleted or otherwise recognized any that did exist, the user is given the option to further amend this basket (perhaps by adding more goods), buying this basket as it currently exists and proceeding to checkout, or moving some or all of the material to a regular “Shopping Basket”. Once the user finishes this process, in the manner explained above, the order is approved (step 166) and the vendor can then process the approved order (step 168). In either case, the purchase ultimately proceeds in the conventional online manner.

It is noted that the use of e-mail to submit the “purchase” list is only one exemplary way of communicating the list desired by the user, and is probably the most convenient way at the present time. In some cases, however, the list could be prepared as a file by the user, and that file can be transmitted directly through the browser during the purchase transaction while the user is in online session. This alternative embodiment is shown in FIG. 8. In accordance with this embodiment, the user prepares the purchase list in an off-line environment (step 180), as in the previous embodiments. The user then logs onto the vendor's site (step 182), and uploads the list into the vendor's system as part of the on-line processing (step 184). In this case, use of e-mail is replaced by a direct online operation from user to vendor, so that any concerns about e-mail security are reduced. Once the order is uploaded, the vendor interprets and places the order in an off-line order basket (step 186), as described above. The user can then review the uploaded order while on-line (step 188), modify the order if desired (steps 190, 192) and eventually approve the order for processing by the vendor (step 194). Once the order is processed, the user logs off the vendor site (step 196).

As can be seen from the description of the invention set forth above, this mixed mode method of processing e-commence transactions has significant advantages. Greater ease and efficiency is provided in connection with on-line ordering because, inter alia, the order can be prepared off-line and transmitted to the vendor's site for review and approval during a future (or current) on-line session. In this way, the amount of effort and time needed to create the order is reduced, together with the amount of time that the user must be on-line with the vendor.

While the preferred forms and embodiments of the invention have been illustrated and described, various changes and modifications may be made to the invention without deviating from the true spirit and scope of the invention, as will be understood by one skilled in the art. It is intended by the appended claims to cover all such modifications and variations, and this claimed invention is not meant to be limited by the specific exemplary embodiments described herein.

What is claimed is:

1. In a system comprising a user and a vendor coupled by a communication system, a method for performing an electronic transaction between the user and the vendor, comprising:
establishing by a user an order list including at least one item to be obtained from the vendor;
submitting the order list to the vendor over the communication system;
receiving the list by the vendor;
making the list available to the user through a real-time connection with the vendor;
establishing a real-time connection between the user and the vendor; and
enabling the user to review and approve the order list during the real-time connection.

2. The method of claim 1, further including identifying by the vendor the user who sent the order list and associating the order list with the user.

3. The method of claim 1, further including enabling the user to modify the order list during the real-time connection and prior to approving the list.

4. The method of claim 1, further including sending the order list to the vendor using e-mail.

5. The method of claim 4, further including establishing the real-time connection using a browser.

6. The method of claim 1, further including establishing the real-time connection using a browser.

7. The method of claim 1, further including using the Internet as the communication system.

8. In a system comprising a user and a vendor coupled by a communication system, a method for performing an electronic transaction between the user and the vendor, comprising:
establishing by a user an order list including at least one item to be obtained from the vendor;
submitting the order list to the vendor over the communication system;
receiving by the user a confirmation of the order list sent by the vendor;
editing the confirmation of the order list by the user to create a modified order list;
sending the modified confirmation order list to the vendor;
making the modified confirmation list available to the user through a real-time connection with the vendor;
establishing a real-time connection between the user and the vendor; and
enabling the user to approve the order list during the real-time connection;

9. The method of claim 8, further including identifying by the vendor the user who sent the order list and associating the list with the user.

10. The method of claim 8, further including enabling the user to modify the order list during the real-time connection and prior to approving the list.

11. The method of claim 8, further including sending the order list to the vendor using e-mail.

12. The method of claim 11, further including establishing the real-time connection using a browser.

13. The method of claim 8, further including establishing the real-time connection using a browser.

14. The method of claim 8, further including using the Internet as the communication system.

15. In a system comprising a user and a vendor coupled by a communication system, a method for performing an electronic transaction between the user and the vendor, comprising:
sending a proposed order list by a vendor to a user;
using the proposed order list by the user to create an order list;
submitting the order list to the vendor over the communication system;
making the order list available to the user through a real-time connection with the vendor;
establishing a real-time connection between the user and the vendor; and
enabling the user to review and approve the order list during the real-time connection;

16. The method of claim 15, further including identifying by the vendor the user who sent the order list and associating the list with the user.

17. The method of claim 15, further including enabling the user to modify the order list during the real-time connection and prior to approving the list.

18. The method of claim 15, further including sending the order list to the vendor using e-mail.

19. The method of claim 18, further including establishing the real-time connection using a browser.

20. The method of claim 15, further including establishing the real-time connection using a browser.

21. The method of claim 15, further including using the Internet as the communication system.

22. In a system comprising a user and a vendor coupled by a communication system, a method for performing an electronic transaction between the user and the vendor, comprising:
establishing by a user a list including at least one item to be obtained from the vendor;
submitting the list to the vendor over the communication system;
receiving the list by the vendor;
parsing the list to extract an order for the vendor;
making the order available to the user through a real-time connection with the vendor;
establishing a real-time connection between the user and the vendor; and
enabling the user to review and approve the order during the real-time connection.

23. The method of claim 22, further including enabling the user to modify the order during the real-time connection and prior to approving the order.

24. The method of claim 22, further including using an automated process to parse the list.

25. The method of claim 22, wherein the communications system is the Internet, and further including using e-mail to submit the list to the vendor and using a browser to establish the real-time connection.

26. The method of claim 24, wherein parsing the list includes scanning the list for delimiters indicating order entries in the list.

27. In a system comprising a user and a vendor coupled by a communication system, a method for performing an electronic transaction between the user and the vendor, comprising:
establishing by a user an order list including at least one item to be obtained from the vendor;
establishing a real-time connection between the user and the vendor;
uploading by the user the order list to the vendor;
receiving the uploaded order list by the vendor;
making the uploaded order list available to the user through a real-time connection;
enabling the user to review and approve the uploaded order list during the real-time connection.

28. The method of claim 27, further including enabling the user to modify the uploaded order list during the real-time connection.
